(19) United States
(12) Patent Application Publication
(10) Pub. No.: US 2022/0089614 A1
(43) Pub. Date: Mar. 24, 2022

(54) SODIUM SQUARATE HEXAHYDRATE COMPLEX

(71) Applicant: Hefei University of Technology, Hefei, AH (US)

(72) Inventor: Mei Luo, Hefei (CN)

(21) Appl. No.: 17/449,663

(22) Filed: Sep. 30, 2021

(30) Foreign Application Priority Data
Sep. 2, 2021 (CN) 202011310884.2

(51) Int. Cl. C07F 1/04

(52) U.S. Cl. CPC C07F 1/04

(57) ABSTRACT

Disclosed is a sodium squarate hexahydrate complex of the structural formula (I). Its synthesis method includes the following steps. 0.6621 g of squaric acid, 2.6128 g of ammonium formate and 100 ml of anhydrous methanol are weighed and put into a 250 mL round-bottom flask, and heated and stirred to reflux for 48 h, then the reaction is stopped, subsequently the flask is added with 10 mL of a 1M HCl solution, and extracted with 3×15 mL of dichloromethane, and then a combined extraction solution is washed again with 15 mL of a 12M NaOH solution, and extracted again with 3×15 mL of dichloromethane. The extraction solution is subjected to rotary evaporation and separation through column chromatography to obtain a crystal complex; the use of this sodium squarate hexahydrate complex (I) is to use the sodium squarate hexahydrate complex (I) as a catalyst.

### TECHNICAL FIELD

The present disclosure relates to a novel compound and use thereof, and in particular to a sodium complex and a preparation method thereof, exactly preparation and use of a sodium squarate hexahydrate complex

### BACKGROUND

A sodium squarate complex is a metal complex. Compounds similar to it have been reported in literature. [1-2] since it is a Lewis acid reagent, it can be developed to be used as an organic catalyst and a pharmaceutical intermediate.

### CITED REFERENCES

1. Temperature Controlled Reversible Change of the Coordination Modes of the Highly Symmetrical Multitopic Ligand To Construct Coordination Assemblies: Experimental and Theoretical Studies. Zheng, Bo; Dong, Hao; Bai, Junfeng; Li, Yizhi; Li, Shuhua; Scheer, Manfred, Journal of the American Chemical Society (2008), 130, (25), 7778-7779.
2. Lanthanide(III) squarates. 2. High diversity of rare coordination modes of the squarate anion in a series of weakly hydrated cerium(III) squarates prepared by pseudo-hydrothermal methods, Trombe, Jean Christian; Petit, Jean Francois; Gleizes, Alain, Inorganica Chimica Acta (1990), 167(1), 69-81.

### SUMMARY

The present disclosure is directed to provide a sodium squarate hexahydrate complex, and a technical problem to be solved is to obtain a target product by one-step synthesis.

The sodium squarate hexahydrate complex referred in the present disclosure is a compound shown by the following chemical formula, which is prepared by reacting squamate with ammonium formate and sodium hydroxide:

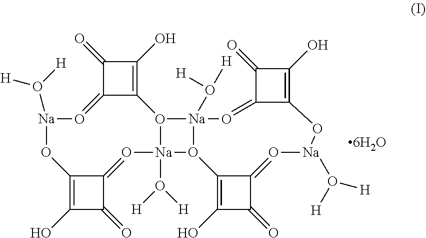

chemical name: sodium squarate hexahydrate complex, referred to as a complex (I) for short. The compound shows a relatively better catalytic performance in a nitrile silicification reaction of benzaldehyde with a conversion rate up to 34.8%.

A synthesis method of the sodium squarate hexahydrate complex includes synthesizing and separating. The synthesizing is dissolving 0.6621 g of squaric acid, 2.6128 g of ammonium formate and 0.0480 g of a palladium complex in 100 ml of absolute methanol, and heating and stirring to reflux for 48 h; then stopping the reaction, subsequently adding 10 mL of a 1M HCl solution, and extracting with 3×15 mL of dichloromethane; then washing a combined extraction solution again with 15 mL of a 12M NaOH solution, and extracting again with 3×15 mL of dichloromethane; subjecting the combined extraction solution to rotary evaporation and separation through column chromatography to obtain a colorless crystal complex.

The synthesis reaction is as follows:

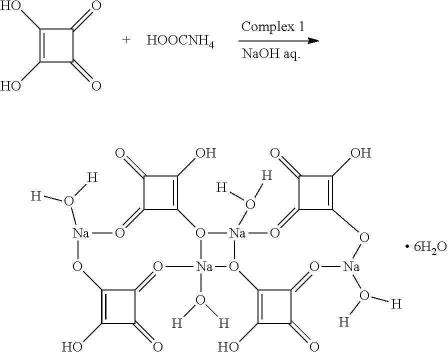

The present synthesis method obtains a target product in one step, with a simple process and convenient operations.

The reaction mechanism of this reaction can be speculated as follows: the unreacted squaric acid interacts with sodium hydroxide to dehydrate, and undergoes a series of changes under the action of the palladium catalyst to form the sodium complex.

### BRIEF DESCRIPTION OF THE DRAWINGS

FIG. 1 is an X-ray diffraction analysis pattern of the sodium squarate hexahydrate complex.

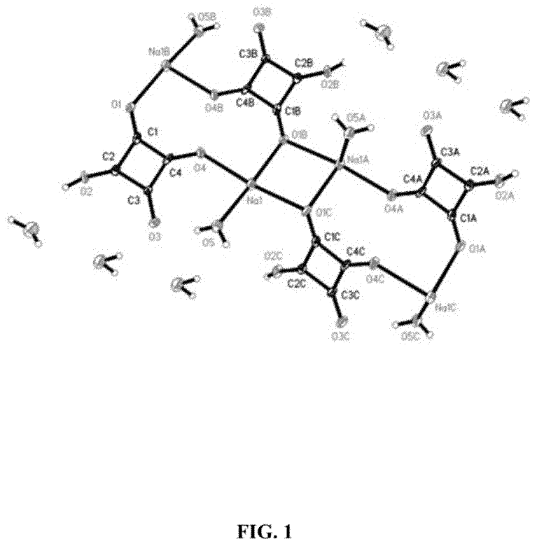

### DETAILED DESCRIPTION OF THE EMBODIMENTS

### 1. Preparation of Palladium Complex:

### (1) Preparation of [1,4-(4R)-diisopropyl-2-oxazolinyl]benzene

Into a 100 mL two-necked flask added were 1.4054 g (10.64 mmol) of anhydrous ZnCl₂, 40 ml of chlorobenzene, 5.0236 g (39.2 mmol) of 1,4-dicyanobenzene and 16.2075 g of L-valinol under anhydrous and oxygen-free conditions. The mixture was refluxed at a high temperature for 60 h, then the reaction was stopped, and the solvent was removed under reduced pressure. The residue was dissolved with water and extracted with CHCl₃ (20 mL×2). The organic phase was dried over anhydrous sodium sulfate and the solvent was removed by rotation. The crude product was subjected to column chromatography with petroleum ether/dichloromethane (4:1) to obtain a light green viscous liquid with a yield of 52%; white crystal with a melting point of: 48-50° C., [a]⁵D=+111.9° (c=0.429, CHCl₃); ¹HNMR (500 MHz, CDCl₃, 27° C.), δ(ppm)=7.97 (s, 4H), 4.39-4.43 (t, 3.18 Hz, 1H), 4.09-4.15 (m, 2H), 1.85-1.86 (m, 1H), (d, J=6.24 Hz, 6H), 0.86-0.96 (d, J=6.24 Hz, 6H). ¹³CNMR 18.13, 19.03, 32.85, 70.26, 72.76, 128.10, 128.16, 130.32, 162.82. IR: 3273, 2976, 2960, 2932, 2889, 2869, 1643, 1512, 1469, 1408, 1382, 1366, 1350, 1320, 1296, 1276, 1214, 1180, 1108, 1077, 1047, 1014, 971, 955, 900, 891, 838, 726, 698, 675, 659, 540. HRMS(EI): m/z (%): calcd for C₁₈H₂₄N₂O₂: 300.1838; found: 300.1833.

### (2) Preparation of Bis{[1,4-(4S)-diisopropyl-2-oxazolinyl Benzene]palladium Chloride} Complex

Into a 100 mL two-necked flask added were 1.5603 g (4.92 mmol) of palladium chloride, 1.0435 g (3.48 mmol) of 1,4-(4R)-diisopropyl-2-oxazolinylbenzene and 30 mL of chlorobenzene. The mixture was refluxed at high temperature for 48 h, the reaction was stopped, and the solvent was removed under reduced pressure. The residue was dissolved in trichloromethane and ethanol, and subjected to natural volatilization of the solvent to obtain a reddish brown complex as a crystal with a yield: 92%; m.p.: >200° C., [a]⁵D=+512.8° (c 0.0564, CH₃OH); ¹H NMR (600 MHz, CDCl3), δ ppm 8.81 (s, 8H, ArH), 4.61-4.63 (m, 4H, CH×4), 4.53 (t, J=9.6 Hz, 4H, CH×4), 4.44 (t, J=8.5 Hz, 4H, CH×4), 3.07-3.10 (m, 4H), 1.18 and 1.15 (dd, J=6.7, 7.2 Hz, 24H, CH3×4); ¹³C NMR (150 MHz, CDCl₃) ppm 166.8, 130.1 (×2), 129.3, 72.0, 69.1, 30.7, 19.0, 15.6; νmax (cm⁻¹) 3487, 3049, 2957, 2929, 2872, 1642, 1609, 1572, 1509, 1480, 1464, 1416, 1379, 1331, 1288, 1246, 1178, 1141, 1123, 1099, 1045, 1018, 959, 933, 899, 854, 804, 770, 722, 693, 438; elemental analysis of C₃₆H₄₈N₄Cl₄O₄Pd₂, test value: C, 45.26%, H, 5.06%, N, 5.86%; theoretical value: C, 45.32%, H, 5.24%, N, 5.48%;

### 2. Preparation of Sodium Squarate Hexahydrate Complex:

0.6621 g of squaric acid, 2.6128 g of ammonium formate and 0.0480 g of a palladium complex were weighed and dissolved in 100 ml of anhydrous methanol, and heated and stirred to reflux for 48 h. Then the reaction was stopped, and subsequently the mixture was added with 10 mL of a 1M HCl solution and extracted with 3×15 mL of dichloromethane. Then the combined extraction solution was washed again with 15 mL of a 12M NaOH solution and extracted again with 3×15 mL of dichloromethane. The extraction solution was subjected to rotary evaporation and separation through column chromatography to obtain 0.3852 g of a crystal complex with a melting point >250° C.; elemental analysis data: theoretical value: C: 26.68%; H: 2.80%; measured value: 6.87%; H: 2.63%; IR spectral data: (KBr; v,cm⁻¹): 3347, 3111, 3032, 2916, 2849, 1597, 1539, 1439, 1393, 1142, 1078, 880, 825, 710; and the crystal data of the compound:

| empirical formula | C16H20Na4O26 | |
|---|---|---|
| molecular weight | 720.28 | |
| temperature | 293(2) K | |
| wavelength | 0.71073 Å | |
| crystal system, space group | monoclinic system, C 2/c | |
| lattice parameter | a = 24.567(15) Å | alpha = 90 deg. |
| | b = 3.580(2) Å | beta = 90 deg. |
| | c = 15.837(10) Å | gamma = 90 deg. |

| | |
|---|---|
| volume | 1380.2(5) Å\hat{ }3 |
| charge density | 2, 1.731 Mg/m\hat{ }3 |
| absorption correction parameter | 0.218 mm\hat{ }−1 |
| number of electrons in a single | 736 |
| lattice | |
| crystal size | 0.110 × 0.060 × 0.040 mm |
| range of Theta angle | 2.592 to 24.996 |
| scope of HKL index collection | −28 <= h <= 28, −4 <= k < 4, |
| | −18 <= l <= 18 |
| collected/independent diffraction | 6015/1204 [R(int) = 0.0909] |
| data | |
| data integrity of theta = 30.5 | 95.9% |
| absorption correction method | multilayer scanning |
| maximum and minimum | 0.7456 and 0.5760 |
| transmittances | |
| method used for refinement | matrix least square method of F\hat{ }2 |
| number of data/limited number | 1204/0/104 |
| for usage/number of parameters | |
| method used for refinement | 1.170 |
| consistency factor of diffraction | R1 = 0.0948, wR2 = 0.2362 |
| points | |
| coincidence factor of observable | R1 = 0.1306, wR2 = 0.2598 |
| diffraction | |
| Maximum peak and valley on | 0.450 and −0.550e.A\hat{ }−3 |
| differential Fourier diagram | |

### Typical Bond Length Data of Crystal:

| | |
|---|---|
| Na(1)-O(5) | 2.347(6) |
| Na(1)-O(4) | 2.350(5) |
| Na(1)-O(1)#1 | 2.397(5) |
| Na(1)-O(5)#2 | 2.401(6) |
| Na(1)-O(1)#3 | 2.445(5) |
| Na(1)-O(1)#4 | 2.585(6) |
| Na(1)-Na(1)#5 | 3.580(2) |
| Na(1)-Na(1)#2 | 3.580(2) |
| Na(1)-Na(1)#6 | 3.580(4) |
| Na(1)-Na(1)#7 | 3.580(4) |
| O(1)-C(1) | 1.235(8) |
| O(1)-Na(1)#8 | 2.397(5) |
| O(1)-Na(1)#3 | 2.445(5) |
| O(1)-Na(1)#4 | 2.585(6) |
| O(2)-C(2) | 1.232(8) |
| O(3)-C(3) | 1.259(7) |
| O(4)-C(4) | 1.281(8) |
| C(1)-C(4) | 1.447(8) |
| C(1)-C(2) | 1.474(9) |
| C(2)-C(3) | 1.475(8) |
| C(3)-C(4) | 1.430(9) |
| O(5)-Na(1)#5 | 2.401(6) |
| O(5)-H(5A) | 0.8503 |
| O(5)-H(5B) | 0.8499 |
| O(6)-H(6A) | 0.9482 |
| O(6)-H(6B) | 0.8497 |
| O(7)-H(7A) | 0.8540 |
| O(7)-H(7B) | 0.8584 |

### Bond Angle Data of Crystal

| | |
|---|---|
| O(5)-Na(1)-O(4) | 91.08(17) |
| O(5)-Na(1)-O(1)#1 | 93.11(18) |
| O(4)-Na(1)-O(1)#1 | 173.1(2) |
| O(5)-Na(1)-O(5)#2 | 97.88(18) |
| O(4)-Na(1)-O(5)#2 | 88.28(18) |
| O(1)#1-Na(1)-O(5)#2 | 96.55(17) |
| O(5)-Na(1)-O(1)#3 | 175.2(2) |
| O(4)-Na(1)-O(1)#3 | 87.48(17) |
| O(1)#1-Na(1)-O(1)#3 | 87.90(17) |
| O(5)#2-Na(1)-O(1)#3 | 86.7(2) |
| O(5)-Na(1)-O(1)#4 | 84.69(19) |
| O(4)-Na(1)-O(1)#4 | 90.18(17) |
| O(1)#1-Na(1)-O(1)#4 | 84.77(16) |
| O(5)#2-Na(1)-O(1)#4 | 177.03(19) |
| O(1)#3-Na(1)-O(1)#4 | 90.70(17) |
| O(5)-Na(1)-Na(1)#5 | 41.63(14) |
| O(4)-Na(1)-Na(1)#5 | 91.86(14) |
| O(1)#1-Na(1)-Na(1)#5 | 87.66(14) |
| O(5)#2-Na(1)-Na(1)#5 | 139.51(14) |
| O(1)#3-Na(1)-Na(1)#5 | 133.78(13) |
| O(1)#4-Na(1)-Na(1)#5 | 43.08(12) |
| O(5)-Na(1)-Na(1)#2 | 138.38(14) |
| O(4)-Na(1)-Na(1)#2 | 88.14(14) |
| O(1)#1-Na(1)-Na(1)#2 | 92.34(14) |
| O(5)#2-Na(1)-Na(1)#2 | 40.49(14) |
| O(1)#3-Na(1)-Na(1)#2 | 46.22(13) |
| O(1)#4-Na(1)-Na(1)#2 | 136.92(12) |
| Na(1)#5-Na(1)-Na(1)#2 | 180.0 |
| O(5)-Na(1)-Na(1)#6 | 90.59(12) |
| O(4)-Na(1)-Na(1)#6 | 131.71(17) |
| O(1)#1-Na(1)-Na(1)#6 | 42.84(13) |
| O(5)#2-Na(1)-Na(1)#6 | 139.08(14) |
| O(1)#3-Na(1)-Na(1)#6 | 86.93(15) |
| O(1)#4-Na(1)-Na(1)#6 | 42.01(10) |
| Na(1)#5-Na(1)-Na(1)#6 | 60.00(4) |
| Na(1)#2-Na(1)-Na(1)#6 | 120.00(4) |
| O(5)-Na(1)-Na(1)#7 | 139.27(14) |
| O(4)-Na(1)-Na(1)#7 | 129.27(16) |
| O(1)#1-Na(1)-Na(1)#7 | 46.18(14) |
| O(5)#2-Na(1)-Na(1)#7 | 89.73(12) |
| O(1)#3-Na(1)-Na(1)#7 | 41.81(10) |
| O(1)#4-Na(1)-Na(1)#7 | 89.27(14) |
| Na(1)#5-Na(1)-Na(1)#7 | 120.00(4) |
| Na(1)#2-Na(1)-Na(1)#7 | 60.00(4) |
| Na(1)#6-Na(1)-Na(1)#7 | 59.99(9) |
| C(1)-O(1)-Na(1)#8 | 126.5(4) |
| C(1)-O(1)-Na(1)#3 | 128.0(4) |
| Na(1)#8-O(1)-Na(1)#3 | 95.35(17) |
| C(1)-O(1)-Na(1)#4 | 114.2(4) |
| Na(1)#8-O(1)-Na(1)#4 | 91.81(17) |
| Na(1)#3-O(1)-Na(1)#4 | 90.71(17) |
| C(4)-O(4)-Na(1) | 134.5(4) |
| O(1)-C(1)-C(4) | 136.1(6) |
| O(1)-C(1)-C(2) | 134.6(5) |
| C(4)-C(1)-C(2) | 89.3(5) |
| O(2)-C(2)-C(1) | 136.2(6) |
| O(2)-C(2)-C(3) | 134.8(6) |
| C(1)-C(2)-C(3) | 89.0(5) |
| O(3)-C(3)-C(4) | 135.9(6) |
| O(3)-C(3)-C(2) | 134.2(6) |
| C(4)-C(3)-C(2) | 89.9(5) |
| O(4)-C(4)-C(3) | 133.2(5) |
| O(4)-C(4)-C(1) | 135.0(6) |
| C(3)-C(4)-C(1) | 91.8(5) |
| Na(1)-O(5)-Na(1)#5 | 97.88(18) |
| Na(1)-O(5)-H(5A) | 112.7 |
| Na(1)#5-O(5)-H(5A) | 97.6 |
| Na(1)-O(5)-H(5B) | 127.6 |
| Na(1)#5-O(5)-H(5B) | 112.7 |
| H(5A)-O(5)-H(5B) | 104.5 |
| H(6A)-O(6)-H(6B) | 85.3 |
| H(7A)-O(7)-H(7B) | 103.4. |

### 3. Application of Nitrile Silicification Reaction

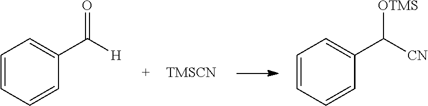

0.05 mmol of a compound I, 0.1 ml of benzaldehyde, 0.3 ml (3.3 mmol) of TMSCN, and the sodium squarate hexahydrate complex of 2 were added sequentially at 20-30° C. After 20 hours, the reaction was quenched by addition of water and subjected to column chromatography (petroleum ether/dichloromethane: 5/1) to obtain a colorless oily liquid with a conversion rate of 34.8%; ¹H NMR (300 MHz, CDCl3) 7.56-7.59 (m, 0.9 Hz, 2H), 7.31-7.34 (m, 3H), 5.43 (s, 1H), 0.16 (s, 9H).

What is claimed is:

1. A sodium squarate hexahydrate complex which is prepared from squarate acid, ammonium formate and sodium hydroxide and represented by the following chemical formula:

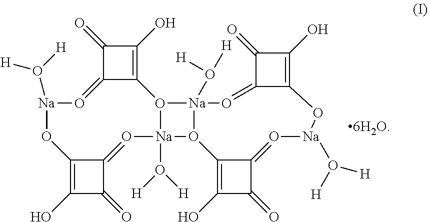

2. The sodium squarate hexahydrate (I) according to claim 1, wherein when diffraction data is collected in a ω-θ scanning manner with a MoKα ray (λ=0.71073 Å) monochromatized by a graphite monochromator on a Oxford X-ray single-crystal diffractometer at a temperature of 293(2) K, it is characterized in that a crystal belongs to a monoclinic system, the space group is: C 2/C, and lattice parameters of the crystal are: a=24.567(15) Å alpha=90 deg; b=3.580(2) Å beta=90 deg; c=15.837(10) Å gamma=90 deg.

3. A method for synthesizing the sodium squarate hexahydrate complex (I) according to claim 1, comprising synthesizing, separating and purifying, wherein the synthesizing is weighing and putting 0.6621 g of squaric acid, 2.6128 g of ammonium formate and 100 ml of anhydrous methanol into a 250 mL round-bottom flask, and heating and stirring to reflux for 48 h; then stopping the reaction, subsequently adding 10 mL of a 1M HCl solution, and extracting with 3×15 mL of dichloromethane; then washing a combined extraction solution again with 15 mL of a 12M NaOH solution, and extracting again with 3×15 mL of dichloromethane; subjecting the extraction solution to rotary evaporation and separation through column chromatography with dichloromethane and anhydrous methanol according to a volume ratio of 9:1 as an eluent, and collecting a final component point to obtain the crystal complex (I).

4. Use of the sodium squarate hexahydrate complex (I) according to claim 1, wherein the sodium squarate hexahydrate complex is used as a catalyst in an addition reaction of benzaldehyde and trimethylsilyl nitrile with a conversion rate up to 34.8%.
